(19) United States
(12) Patent Application Publication
(10) Pub. No.: US 2004/0192102 A1
(43) Pub. Date: Sep. 30, 2004

(54) Insertion apparatus and method

(76) Inventor: Gary Edward Burton, San Diego, CA (US)

Correspondence Address: KIRKPATRICK & LOCKHART LLP, 535 SMITHFIELD STREET, PITTSBURGH, PA, 15222, US

(21) Appl. No.: 10/403,267

(22) Filed: Mar. 31, 2003

(51) Int. Cl. H01R 13/64

(52) U.S. Cl. 439/374

(57) ABSTRACT

An apparatus and method for installing a semiconductor component on a substrate such as a printed circuit board. One embodiment may include a placement tool that defines an opening for receiving a semiconductor component therein. The body may have a guide for aligning the semiconductor component within the opening and one or more other guides for aligning the placement tool relative to the substrate. One or more gripper arms may be pivotally attached to the body member for releasably gripping an interconnect device therewith. The method may include placing an insertion tool over an interconnect device, seating the insertion tool over the interconnect device, transporting the interconnect device to an assembly area, placing the interconnect device on a substrate, inserting a semiconductor component into the interconnect device, and releasing the interconnect device and the semiconductor component from the tool.

### BACKGROUND

Interconnect devices (e.g., interposers) are used to connect semiconductor components to a substrate. Semiconductor components may include, for example, microprocessors, application specific integrated circuit (ASIC) devices, programmable logic array devices, packaged semiconductor devices, semiconductor modules, semiconductor chip set arrays, and other digital, analog, and/or mixed signal integrated circuit components. Substrates may include, for example, printed circuit boards, ceramic, flexible circuits, and other substrates suitable for permanently or temporarily attaching semiconductor components thereto. Today's growing and technologically demanding semiconductor manufacturing assembly processes require high-density interconnect devices for connecting the semiconductor components to the substrates. For example, high-density surface mount semiconductor socket connectors having over 1,000 high-density contacts often serve as the interconnect devices to accommodate the increased complexity and functionality of modem semiconductor components.

High-density contacts, however, are prone to damage while operators or assembly machines handle the semiconductor components, interconnect components, and the substrate during the assembly process. For example, if an interconnect device having high-density contacts is not properly aligned with its corresponding substrate, the contacts or the substrate may become damaged as the interconnect device is placed thereon. Similarly, if a semiconductor component is not properly aligned with its corresponding interconnect device, the contacts or the semiconductor component may become damaged as the semiconductor component is inserted into the interconnect device.

Accordingly, there exists a need for apparatuses and methods for facilitating the attachment of semiconductor components and corresponding interconnect devices to a substrate while minimizing the potential for damaging the semiconductor components, interconnect devices, and/or substrates during the assembly process.

### SUMMARY

In one general respect, an embodiment of the present invention is directed to an apparatus, including a body having at least one alignment guide thereon, the body defining an opening for receiving a semiconductor component therein; and a first gripper arm pivotally attached to the body.

According to another embodiment, the present invention is directed to an apparatus that includes a first member having a top portion and a bottom portion, the first member having a first downwardly projecting edge; a second member having a top portion and a bottom portion, the second member located opposite the first member and pivotally attached to the first member, the second member having a second downwardly projecting edge; and a spring disposed between the first and second members for applying a bias force against the first and second members to keep the top portions of the first and second members apart from one another and to keep the bottom portions of the first and second members biased toward one another; wherein the first and second downwardly projecting edges are for engaging an interconnect device and for holding the interconnect device with a spring force generated by the spring acting on a sidewall of the interconnect device, the spring force being generated by the spring.

In yet another embodiment, the present invention is directed to a method of assembling a semiconductor component using an insertion tool. The method includes placing an insertion tool over an interconnect device; seating the insertion tool over the interconnect device; transporting the interconnect device to an assembly area; placing the interconnect device on a substrate; inserting a semiconductor component into the interconnect device; and releasing the interconnect device and the semiconductor component from the tool.

In still another embodiment, the present invention is directed to a semiconductor component system, including a substrate; a semiconductor component; an interconnect device for interconnecting the semiconductor component to the substrate; and a placement tool including a body; and a pair of opposed grippers on the body for selectively retaining and releasing the interconnect device.

In yet another embodiment, the present invention is directed to an apparatus, including a first member having a top portion and a bottom portion, the first member having a first downwardly projecting edge; a second member having a top portion and a bottom portion, the second member located opposite the first member and pivotally attached to the first member, the second member having a second downwardly projecting edge; and a biaser disposed between the first and second members for applying biasing forces to the first and second members to bias the bottom portions of the first and second members toward one another for releasably retaining an interconnect device between the first and second downwardly projecting edges.

In still another embodiment, the present invention is directed to a tray for receiving interconnect devices, including a cell. The cell further includes a planar lower surface; a support surface formed on the lower surface; and an access recess formed within the support surface.

In yet another embodiment, the present invention is directed to a method of assembling a semiconductor component using an insertion tool. The method includes aligning an insertion tool with an interconnect device; retainably engaging the interconnect device with the insertion tool; transporting the interconnect device to an assembly area; placing the interconnect device on a substrate; inserting a semiconductor component into the interconnect device; and releasing the interconnect device and the semiconductor component from the tool.

### DESCRIPTION OF THE DRAWINGS

Embodiments of the present invention are described herein in conjunction with the following figures, wherein:

FIG. 1 is a perspective view of a tool according to one embodiment of the invention;

FIG. 2 is a perspective view of the tool shown in FIG. 1 showing some of the elements thereof in an exploded assembly arrangement;

FIG. 3 is a cross-sectional view of the tool of FIG. 1 taken along line III-III in FIG. 1 and illustrated holding an interconnect device, wherein the tool is also illustrated in phantom in an open position for receiving and releasing an interconnect device;

FIG. 4 is a perspective view of a tray, an interconnect device, a semiconductor component, a substrate, and a tool according to one embodiment of the present invention;

FIG. 5 is a perspective view of an interconnect device for use with a tool according to one embodiment of the invention, wherein a portion of the contacts is shown enlarged;

FIGS. 6A and 6B are perspective views of a tool according to another embodiment of the invention, wherein the tool is holding an interconnect device;

FIG. 6C is a cross-sectional view of the tool shown in FIGS. 6A and 6B holding an interconnect device, wherein the tool is shown in phantom in an open position for receiving and releasing an interconnect device;

FIG. 7 is flow diagram of one method for assembling an interconnect device and a semiconductor component using a tool according to one embodiment of the present invention;

FIGS. 8, 9, 10, and 11 illustrate one method for assembling an interconnect device and a semiconductor component according to one embodiment of the method shown in FIG. 7;

FIG. 12 is a perspective view of an assembled printed circuit board with a semiconductor component and interconnect device;

FIG. 13A illustrates a tray according to another embodiment of the present invention;

FIG. 13B is a cross-sectional view of the tray taken along line XIIIB-XIIIB in FIG. 13A; and

FIG. 13C is a cross-sectional view of the tray taken along line XIIIC-XIIIC in FIG. 13A.

### DESCRIPTION

In one embodiment, the present invention is directed to an apparatus and method for assembling a semiconductor component and a corresponding interconnect device onto a substrate. The apparatus allows an operator or assembly machine to handle the interconnect device and, at the same time, minimizes the likelihood of damaging the interconnect device, the semiconductor component, or the substrate during the handling process. The apparatus also may be used to guide and place the semiconductor component into a final assembly position on the substrate so as to minimize damage to the electrical contacts on the interconnect device and the semiconductor component. When used in this manner, the apparatus nests over the interconnect device and automatically grips it allowing an operator or assembly machine to retainingly engage, transport, and place the interconnect device proximate to a substrate suitable for receiving the interconnect device and the semiconductor component. Once the interconnect device and the semiconductor component are properly aligned on the substrate, they are electrically mated to each other. Finally, the apparatus may be designed to release both devices on the substrate, leaving them in position for final attachment to the substrate.

When the interconnect device is properly aligned and positioned on the substrate, the apparatus is ready for receiving the appropriate semiconductor component to be electrically mated therewith. To assist the assembly process and to minimize the likelihood of damaging the interconnect device and/or the semiconductor component, the apparatus according to one embodiment of the invention may include an opening for receiving the semiconductor component and may also include features for guiding the semiconductor component horizontally into position above the interconnect device contained within the apparatus. This embodiment of the apparatus may also include features for guiding the semiconductor component vertically downwardly onto the interconnect device such that the two are properly aligned when they are mated. This embodiment of the apparatus may further include features that displace spring arm portions of the interconnect device, if any are present, as the semiconductor component is guided vertically downwardly into a mating position with the interconnect device. The displacement action can minimize the likelihood of any sharp edges that may be present in certain semiconductor components, for example those housed in ceramic packages, from scraping off plastic material from the spring arm portions of the interconnect device. The plastic scrapings can be problematic because they may become lodged under a contact portion of the interconnect device and lead to a faulty open circuit condition.

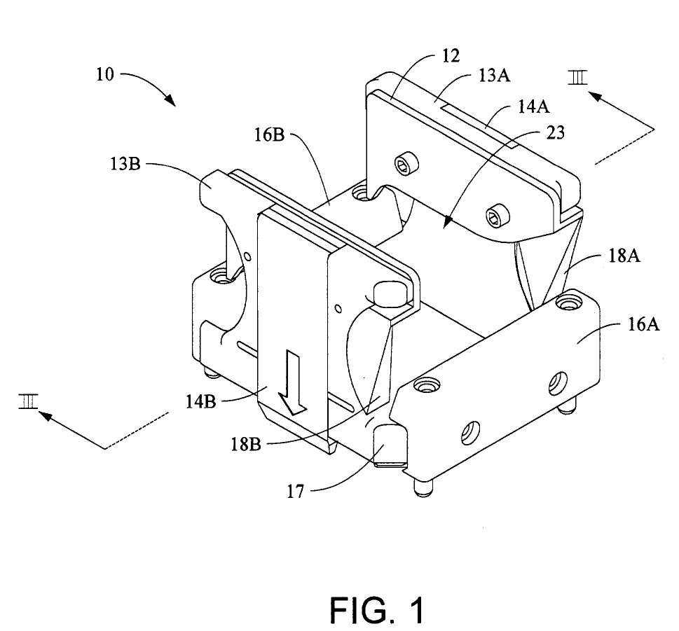

FIG. 1 illustrates a tool 10 in accordance with one embodiment of the present invention. The tool 10 may be used for retrieving and gripping a semiconductor interconnect device and guiding a semiconductor component into a mating position with the interconnect device as will be discussed in further detail below. The tool 10 can reduce the likelihood of damaging either the interconnect device or the semiconductor components while handling during the assembly process. The tool 10 also guides and places the semiconductor component into place above the interconnect device prior to their final attachment to the substrate.

In one embodiment, the tool 10 includes a body portion 12, which is the structure to which all other components may be attached and aligned. The body 12 may be formed from any suitable engineering material such as a metal, alloy, plastic, or ceramic used in the fabrication of machinery, machinery components, structural shapes, tools, instruments, and other items. Their hardness, strength, machinability, dimensional stability, nonflammability, and resistance to corrosion, acids, solvents, and heat may characterize the properties of such suitable engineering materials. One example of a list of such suitable engineering materials include but are not limited to: metals and alloys such as aluminum, beryllium, brass, bronze, cast iron, copper, lead, magnesium, steel, tantalum, zinc, zirconium, and various other trademarked alloys; ceramics such as glass and porcelain; and plastics such as ABS resin, acetal resin, acrylic resin, fluorocarbon polymer, nylon, phenolformaldehyde resin, polybutilene terephthalate, polycarbonate, polyethylene, polyphenylene oxide, polypropylene, polystyrene, polyvinyl chloride, reinforced plastics (FRP), and ureaformaldehyde resin. In one embodiment of the invention the body 12 may be machined from 6061 aluminum or may be formed, for example, from an epoxy-based non-abrasive material. The body 12 may include first and second vertically extending members 13A, B that are positioned parallel to one another and may further include first and second pivotally moveable gripper arms 14A, B pivotally mounted to each vertical member 13A, B, respectively. The tool 10 also may include first and second alignment slider blocks 16A, B located on both sides of and substantially perpendicular to the vertical members 13A, B. The vertically extending members 13A, B and the first and second alignment slider blocks 16A, B define an opening 23 for receiving a semiconductor component. On one side of each of the vertical members 13A, B the tool 10 also may include first and second guides 18A, B. The body 12 also may include a beveled corner 17 for aligning and orienting the tool 10 with the interconnect device, the semiconductor component, and the substrate.

The tool 10 may be adapted to be manually used or operated by a machine. In one embodiment of the present invention, the tool 10 may be ergonomically designed to minimize repetitive motion of the finger and wrist associated with the use of the tool 10 by an operator during the assembly process.

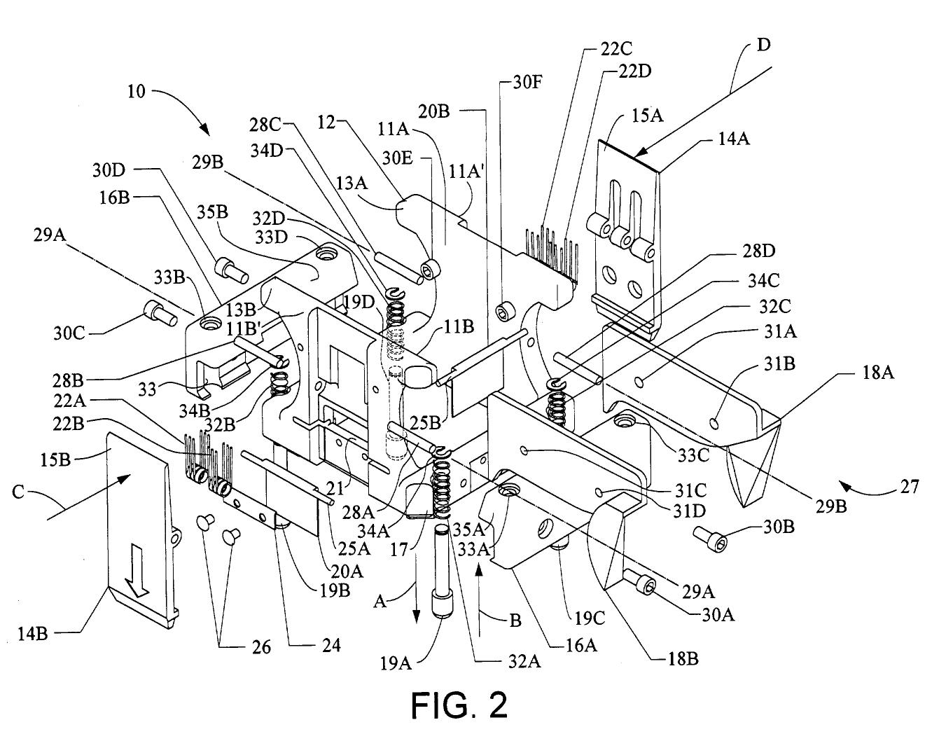

FIG. 2 is an exploded view of the tool 10 shown in FIG. 1 and also illustrates four alignment sliders 19A, B, C, D and spring arm depressors 20A, B, which will be discussed in more detail hereinbelow. In one embodiment of the present invention, the tool 10 may include conventional torsion springs 22A, B, C, D, a keeper 24, fasteners 26, dowel pins 28A, B, C, D, bolts 30A, B, C, D, E, F, springs 32A, B, C, D, and retaining rings 34A, B, C, D. Vertical member 13A may include an inner wall 11A and an outer wall 11A′. Similarly, vertical member 13B may include an inner wall 11B and an outer wall 11B′. A description of the various embodiments of the elements comprising the tool 10 is described in further detail hereinbelow. Those skilled in the art will appreciate, however, that these elements may be varied without departing from the scope of the invention.

In this embodiment, the guide 18A may be removably attached to the vertical member 13A by removable fasteners such as bolts 30E, F that extend through the mounting holes 31A, B. Similarly, the guide 18B may be removably attached to the vertical member 13B with additional fasteners (not shown) that extend through mounting holes 31 C, D. As will be discussed in further detail below, the guides 18A, B guide and align the semiconductor component as it is inserted into the tool 10 and as it is inserted into the interconnect device 40. While the semiconductor component is being inserted into the tool 10, the guides 18A, B provide a low friction bearing surface to reduce the likelihood of abrading the semiconductor component. In one embodiment of the present invention, the guides 18A, B may be made of a precision-formed epoxy-based non-abrasive material (e.g., plastic) for guiding the semiconductor component into a position above the interconnect device 40 without abrading the semiconductor component. Such precision-formed epoxy plastic can also reduce the overall weight of the tool 10. In one embodiment of the present invention, the guides 18A, B may be removed from one side of the tool 10 and attached to the opposite side of the tool 10 to accommodate a desired orientation dictated by an operator or by an assembly machine configuration. For example, the guides 18A, B may be attached to the tool 10 to accommodate right-handed or left-handed operations.

In this embodiment, the alignment slider blocks 16A, B may be removably attached to the body 12 with bolts 30A, B, C, D. The alignment slider blocks 16A, B also may include chamfered surfaces 35A, B to help guide the semiconductor component into the inner portion of the tool 10 above the interconnect device 40 while also providing a low friction and a low abrasion surface for the bottom portion of the semiconductor component to slide on as it is inserted into the tool 10. As will be discussed in further detail below, in one embodiment of the present invention, the alignment slider blocks 16A, B also may be made of a precision-formed epoxy-based non-abrasive material to reduce weight and friction. However, the alignment slider blocks 16A, B may be fabricated from other materials without departing from the scope of the present invention.

The alignment sliders 19A, B, C, D are located within apertures 33 and 33A, B, C, D formed within the alignment slider blocks 16A, B which allow the alignment sliders 19A, B, C, D to slidably move therein. The upper portions of the alignment sliders 19A, B, C, D extend through the apertures 33A, B, C, D, respectively. Corresponding springs 32A, B, C, D bias the alignment sliders 19A, B, C, D, respectively, such that they protrude below a bottom surface of the alignment slider blocks 16A, B (in the direction represented by arrow “A”). The retaining rings 34A, B, C, D retain the alignment sliders 19A, B, C, D within the apertures 33A, B, C, D, respectively, formed within the alignment slider blocks 16A, B. Furthermore, the alignment sliders 19A, B, C, D also may provide for course alignment between the tool 10 and bolster plate holes or standoffs of a printed circuit board. The spring-loaded alignment sliders 19A, B, C, D retract (in the direction represented by arrow “B”) within the apertures 33A, B, C, D when a slight downward force is applied to the top of the tool 10 while the sliders 19A, B, C, D are contacting a surface. This feature may be useful when the tool 10 is used to engage an interconnect device that is located on a flat surface other than a shipping tray. In one embodiment of the present invention, the alignment sliders 19A, B, C, D may be machined from 6061 aluminum to minimize weight and increase durability, for example.

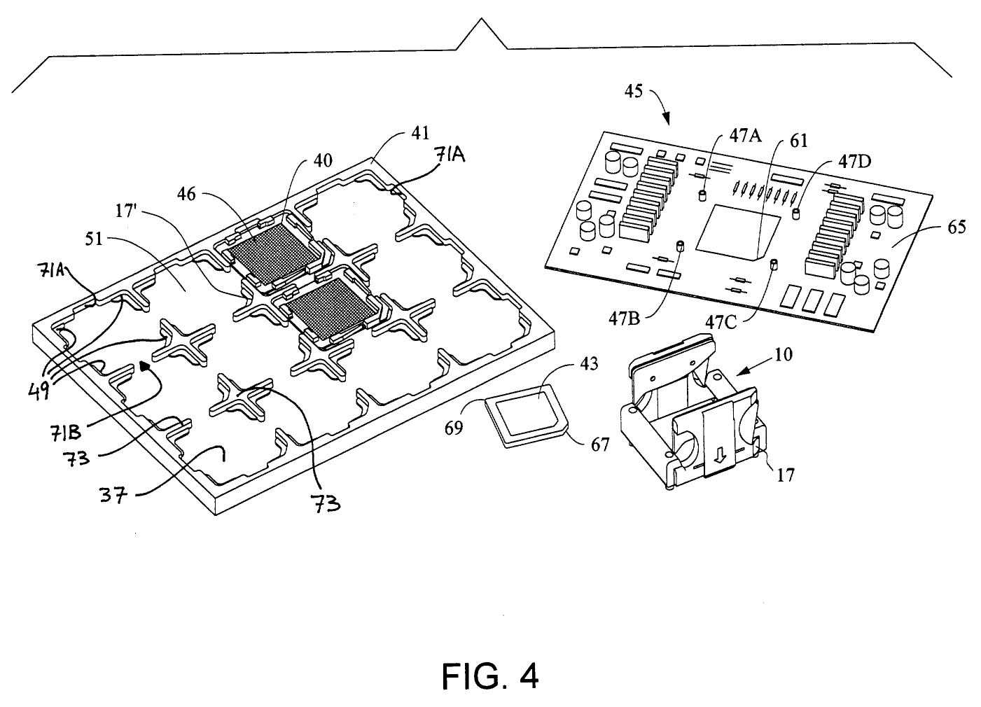

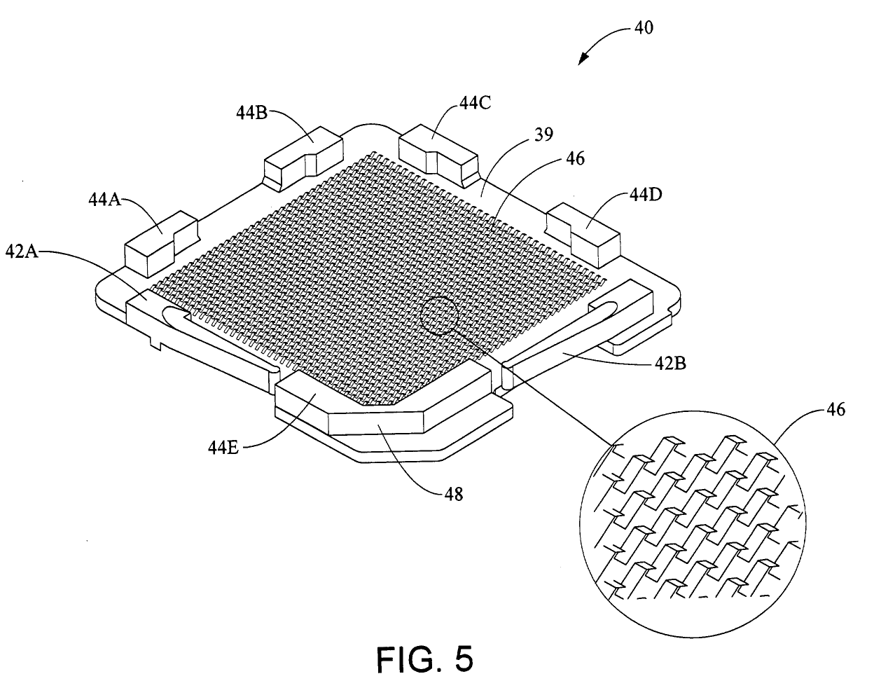

As will be discussed in further detail below, an interconnect device, such as the interconnect device 40 shown in FIGS. 4 and 5, may include spring arms 42A, B (see FIG. 5), which apply a biasing force against a semiconductor component and retain it therebetween after it is inserted in the interconnect device 40. One embodiment of the present invention also includes first and second spring arm depressors 20A, B to displace the spring arms 42A, B of the interconnect device 40 in an outwardly direction as the tool 10 is lowered onto the interconnect device 40 so that the spring arms 42A, B do not interfere with the placement of a semiconductor component on the interconnect device 40 (see FIG. 1). While the tool 10 is lowered onto the interconnect device 40, the spring arm depressors 20A, B are interposed between the spring arms 42A, B, respectively, and a frame 39 of the interconnect device 40 such that the spring arms 42A, B are displaced out of the way of the semiconductor component as it is inserted into the interconnect device 40. The spring arm depressors 20A, B may be manufactured from stainless steel or other suitable material that is durable and has suitable low friction/abrasion properties. The first spring arm depressor 20A may have an attachment rod 25A formed on an end thereof that may be inserted in a slot 21 formed in the vertical member 13B. The attachment rod 25A may be retained within slot 21 by a retainer 24 that is coupled to the vertical member 13B by appropriate fasteners such as, for example, screws 26. The fasteners 26 may be any type of suitable fastener including rivets, screws, bolts, dowels, and the like. The second spring arm depressor 20B may also include an attachment rod 25B and may be attached to a side portion 27 of the tool 10 by way of suitable fasteners (not shown). The second spring arm depressor 20B may be retained between the alignment slider block 16A and the tool body 12 by appropriate fasteners. The fasteners may include any suitable fastener such as rivets, screws, bolts, dowels, and the like.

Also in this embodiment, the gripper arms 14A, B may be pivotally attached to the vertical members 13A, B, respectively, of the tool body 12. For example, the first gripper arm 14A may be attached to the vertical member 13A of the tool body 12 with corresponding dowel pins 28C, D that are pressed into corresponding holes in the vertical member 13A. Similarly, the second gripper arm 14B may be pivotally attached to the vertical member 13B of the tool body 12 with dowel pins 28A, B. The dowel pins 28A, B define a pivot axis 29B (See FIG. 2) about which the gripper arm 14B may pivot. Similarly, dowel pins 28C, D define another pivot axis 29A (See FIG. 2) about which gripper arm 14A may pivot. Conventional springs 22A B, C, D apply a closing bias to the gripper arms 14A, B. Therefore, an opening force must be applied against the top portion 15A, B of the gripper arms 14A, B (in the direction represented by arrows “C” and “D”) to overcome the biasing force of the gripper biasing springs 22A, B, C, D to cause the gripper arms 14A, B to pivot about pivot axes 29A, B, respectively, to an “open” position for receiving an interconnect device 40 therebetween, or for releasing an interconnect device 40 onto a printed circuit board substrate. Once the tool 10 is placed over the interconnect device 40, releasing the opening force on the gripper arms 14A, B causes the lower ends thereof to pivot into retaining engagement with the interconnect device 40. The gripper biasing springs 22A, B, C, D provide the retaining force. The interconnect device 40 may be released by applying the opening force against the gripper arms 14A, B to overcome the bias force of the gripper biasing springs 22A, B, C, D.

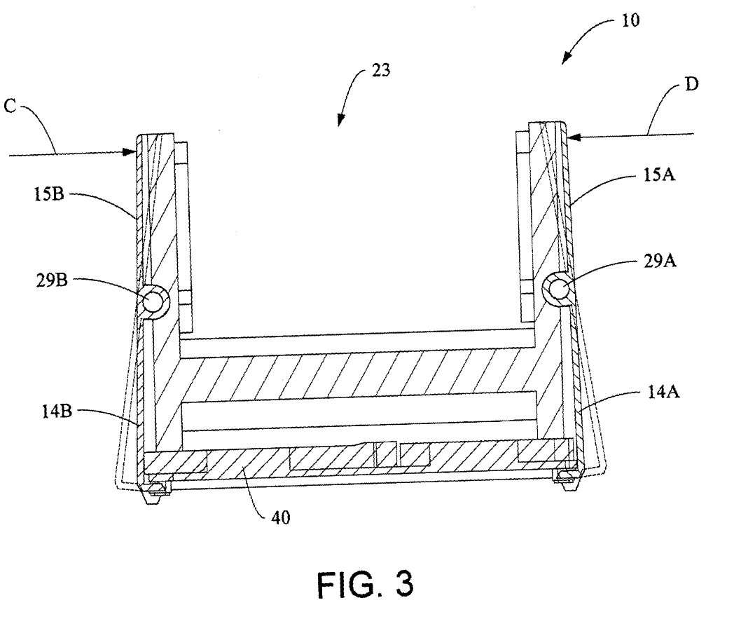

FIG. 3 illustrates a cross section of the tool 10 taken along line III-III in FIG. 1 according to one embodiment of the present invention holding an interconnect device 40, wherein the tool 10 is shown in phantom in an open position for receiving and releasing the interconnect device 40. When forces are applied to the top portions 15A, B of the gripper arms 14A, B in the direction indicated by arrows “C” and “D,” the gripper 14A pivots about pivot axis 29A and the gripper arm 14B pivots about pivot axis 29B so as to place the tool 10 in the “open” position for receiving or releasing the interconnect device 40.

FIG. 4 illustrates a tool 10 according to one embodiment of the present invention, a pair of semiconductor interconnect devices 40 stored in a tray 41, a semiconductor component 43, and a printed circuit board substrate 45. In this example, the interconnect device 40 and the semiconductor component 43 are designed to be mounted to a top side 65 of the printed circuit board substrate 45.

The tray 41 may be used to house and transport the interconnect devices 40 as well as to present the interconnect devices 40 to the insertion tool 10. The tray 41 may serve as a work platform or work surface that presents the interconnect devices 40 to the insertion tool 10 in a pre-aligned and pre-oriented format. In addition, the tray 41 may include specific geometric features that enable the insertion tool 10 to dock, clasp, retain, and remove an interconnect device 40 and mate it to a semiconductor component 43 for subsequent placement of the mated set onto the printed circuit board substrate 45 as an integral unit. The tray 41 may be thermoformed out of a suitable plastic engineering material and may include at least one recessed cell 51 formed therein to accommodate, align, and orient the interconnect devices 40 for shipping, storing, or for presenting the interconnect devices 40 to the insertion tool 10 or the semiconductor components 43 prior to their final assembly onto the printed circuit board substrate 45.

In one embodiment of the present invention the tray 41 may include a plurality of cells 51 arranged in a matrix configuration. Each cell 51 may include a beveled corner 17′ for aligning the interconnect device 40 within the cell 51. The cell 51 also may include a planar lower surface 37 and a support surface 73 formed on the lower surface 37 comprising ledge segments 49 for holding the interconnect device 40 within the cell 51. Each cell 51 also may include access recesses 71A, B for guiding the insertion tool 10 into the cell 51. The access recesses 71A, B define a space to allow the gripper arms 14A, B to move to an open position for receiving and engaging the interconnect device 40 therebetween in order to retrieve the interconnect device 40 from the tray 41. In one embodiment of the present invention, the access recesses 71A may be in the form of cavities defined within the frame structure of the tray 41 or the support surface 73 of the cell 51. The access recesses 71B also may take the form of openings defined between adjacent cells 51.

The printed circuit board substrate 45 may include standoffs 47A, B, C, D and a bevel designation 61 on a guide that may be silk screened onto the circuit board substrate 45 to assist in properly aligning the tool 10 carrying the interconnect device 40 with the printed circuit board substrate 45. The semiconductor component 43 may likewise include a beveled corner 67 to properly align it with the interconnect device 40 and the tool 10. For example, the beveled corner 67 may be so oriented such that the corner 69 of the semiconductor component 43 located opposite the beveled corner 67 may be initially inserted into the tool 10 opening 23 first to commence the insertion process.

In one embodiment of the present invention, the tool 10 may be used to pick up (e.g., retainingly engage), transport, and place the interconnect device 40 (e.g., a Teledyne 1369 land grid array (LGA) socket, connector, and/or interposer connector or other types of devices) of the type shown in FIG. 5. Such process may be commenced by placing the tool 10 over the interconnect device 40 while it is supported in the tray 41. Thereafter, the tool 10 is pressed downwardly onto the interconnect device 40 such that a lower portion of the gripper arms 14A, B biasly engage the interconnect device 40. With the interconnect device 40 held between the gripper arms 14A, B, the tool 10 is then aligned with the standoffs 47A, B, C, D on the printed circuit board substrate 45 using the alignment sliders 19A, B, C, D as guides. The tool 10 then may be placed on the printed circuit board substrate 45 without damaging the interconnect device 40 or the printed circuit board substrate 45. The semiconductor component 43 is then inserted through the opening 23 of the tool 10 such that the interconnect device 40 and the semiconductor component 43 are properly aligned. The semiconductor component 43 and the interconnect device 40 then are electrically mated by applying a downward force to the semiconductor component 43.

The semiconductor interconnect device 40 that may be used in conjunction with one embodiment of the tool 10 according to the present invention will now be described with reference to FIG. 5. The interconnect device 40 may include a frame 39, datum edges 44A, B, C, D, E, spring arms 42A, B, contacts 46, and a beveled edge 48. The tool 10 according to one embodiment of the present invention cooperates with the datum edges 44A, B, C, D, E to help guide the tool 10 while engaging the interconnect device 40 within the gripper arms 14A, B. The beveled edge 48 cooperates with the beveled corner 17 of the tool 10 to properly align and orient the tool 10 with the interconnect device 40. This also establishes a desired alignment for the semiconductor component 43 and the printed circuit board substrate 45. In one embodiment of the present invention, the spring arm depressors 20A, B of the tool 10 displace the spring arms 42A, B by interposing themselves between the frame 39 and the spring arms 42A, B. This prevents the spring arms 42A, B from interfering with the semiconductor component 43 as it is mated with the interconnect device 40.

The interconnect device 40 may be a “low-profile” flush mount solderless interconnect device for electrically engaging a surface mount semiconductor component 43. It will be understood that this particular type of interconnect device 40 provides an electrical connection for land grid array (LGA) applications and may be suitable for microprocessors, ASICs, programmable logic arrays, digital, analog, and/or mixed signal integrated circuit components, and other large semiconductor packages used in computer, server, workstation, and test instrument applications. The interconnect device 40 may be formed out of a liquid crystal polymer (LCP) plastic matrix containing an array of high-density metal contacts 46 (up to 1.00 mm contact spacing, for example). The contacts 46 may have a relatively short length to keep the inductance low at high frequencies, and include a positive stop to prevent overstressing of the contacts 46 when the semiconductor component 43 is inserted therein.

In one embodiment of the present invention, the tool 10 facilitates the alignment and placement of the mating semiconductor component 43 onto the interconnect device 40 to reduce the likelihood of mis-inserting the semiconductor component 43 into the interconnect device 40 by an operator or assembly machine. In one embodiment of the present invention, the tool 10 may be adapted to engage and temporarily hold the interconnect device 40 within its gripper arms 14A, B and place it precisely on a printed circuit board substrate 45. The tool 10 provides a way to precisely align the semiconductor component 43 and the interconnect device 40 through the opening 23 portion of the tool 10 such that the semiconductor component 43 and the interconnect device 40 can be electrically engaged when they are mated to each other without damaging any of the contacts 46. In one embodiment of the present invention, the tool 10 also includes the alignment sliders 19A, B, C, D that place the tool 10 in a proper alignment with the standoffs 47A, B, C, D located on the printed circuit board 45. In particular, the alignment sliders 19A, B, C, D are brought into contact with standoffs 47A, B, C, D, respectively. As the tool 10 is then pressed towards the printed circuit board 45, the alignment sliders 19A, B, C, D retract in the direction shown by arrow “B” to permit the tool 10 to be placed in close proximity of the printed circuit board substrate 45 for placing the interconnect device 40 thereon.

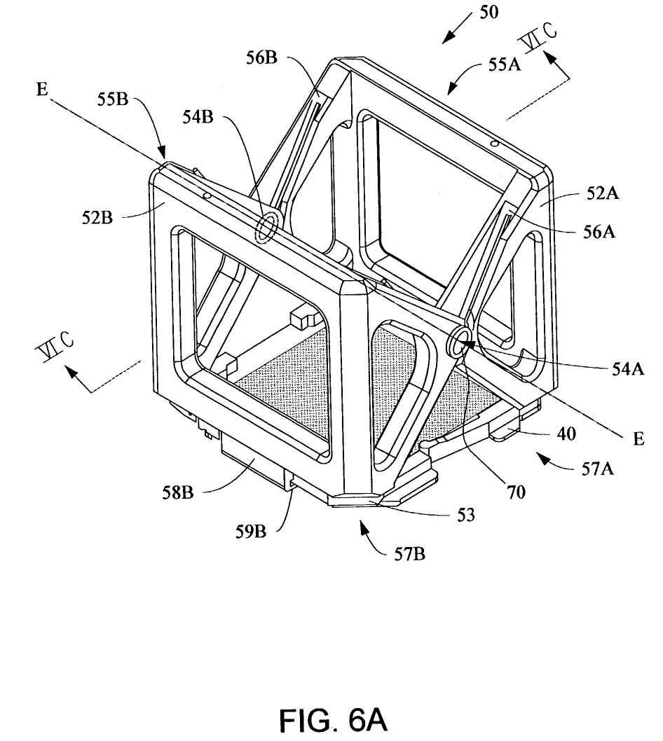

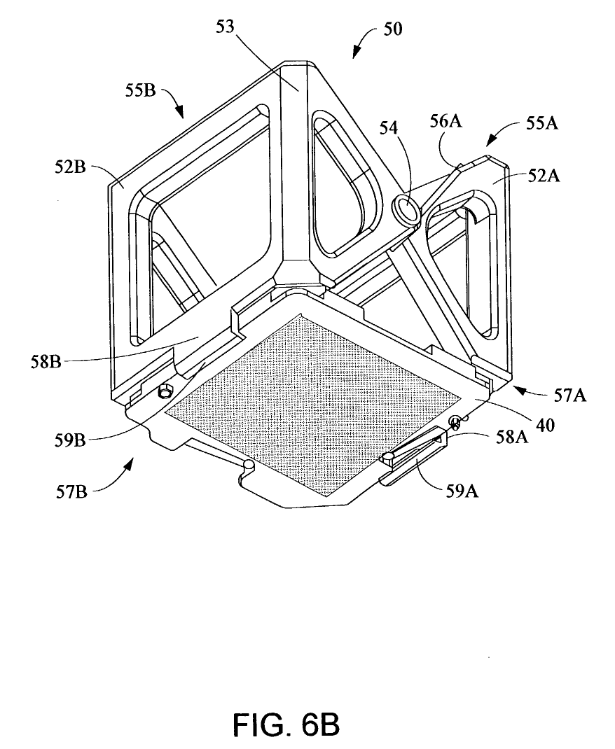

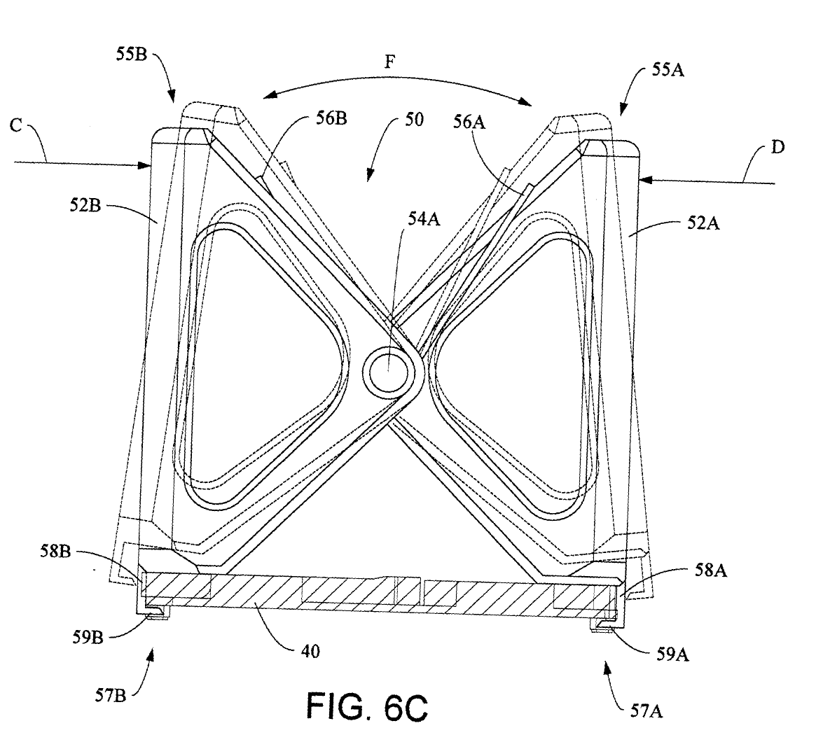

FIGS. 6A, B, and C illustrate a tool 50 according to another embodiment of the present invention supporting an interconnect device 40 therein. FIG. 6C is a cross-sectional view of the tool 50 and interconnect device 40 shown in FIGS. 6A and 6B taken along line VIC-VIC in FIG. 6A. FIG. 6C also illustrates the tool 50 in phantom lines to depict an open position for receiving and releasing the interconnect device 40. The tool 50 may include a first member 52A and an opposing second member 52B. The first member 52A and the second member 52B may be attached at first and second pivot points 54A, B by way of fasteners such as pivot pins 70 or other suitable fasteners. Such pivot pins 70 define a pivot axis E-E about which the first member 52A and the second member 52B may pivot relative to each other. See FIG. 6A. The first and second members 52A, B each may include top portions 55A, B for handling by human or machine, and bottom portions 57A, B for engaging an interconnect device 40. The bottom portions 57A, B of the first and second members 52A, B each may include downwardly projecting edges 58A, B having laterally projecting shoulders 59A, B extending inwardly towards an inner portion of the tool 50. The laterally projecting shoulders 59A, B define corresponding edges for supporting the interconnect device 40. Conventional tension springs 56A, B may be supported on the pivot pins defining points 54A, B. The springs 56A, B apply opposing biasing forces on the first and second members 52A, B which are represented by arrow F in FIG. 6C. The downwardly projecting edges 58A, B engage and hold the interconnect device 40 by gripping the edges of the interconnect device 40. The spring force alone may be adequate for retaining the interconnect device 40 between the downwardly projecting edges 58A, B and the laterally projecting shoulders 59A, B. The tool 50 may also include a beveled corner 53 for facilitating alignment of the tool 50 with the beveled corner 48 of the interconnect device 40.

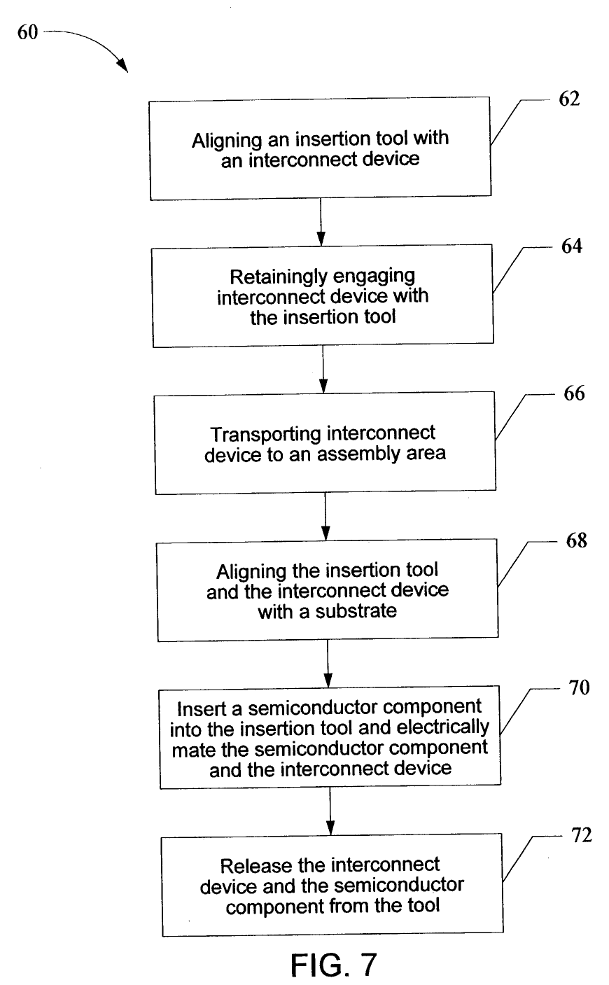

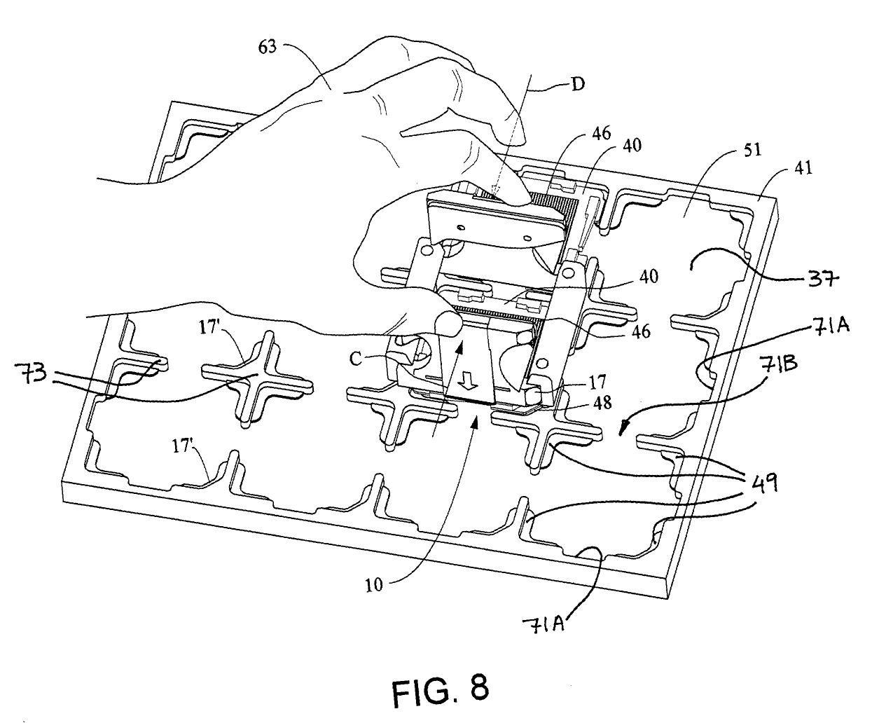

One embodiment of a method of assembling an interconnect device 40 and a semiconductor component 41 is illustrated in FIGS. 7-11. FIG. 7 is a flow diagram 60 of a method of assembling an interconnect device 40 and a semiconductor component using the tool 10, 50 according to one embodiment of the present invention. At step 62, the tool 10, 50 is aligned with the interconnect device 40. As shown in FIG. 8, the interconnect device 40 may be located in the shipping tray 41, for example. In one embodiment of the present invention, the beveled corner 17 of the tool 10 may be aligned with the beveled corner 48 of the interconnect device 40 in the tray. Similarly, the beveled corner 53 of the tool 50 may be used to align the tool 50 with the beveled corner 48 of the interconnect device 40. These features of this embodiment serve to ensure that the tool 10, 50 is aligned with the interconnect device 40. The tool 10, 50 is positioned over the interconnect device 40, with its beveled corner 17, 53, respectively, aligned with the beveled corner 48 of the interconnect device 40 and the beveled corner 17′ of each cell 51 in the tray 41.

After the tool 10, 50 is aligned with the interconnect device 40, it may be lightly rested thereon while applying biasing forces to the gripper arms 14 A, B. Forces in the direction represented by arrows “C” and “D” may be applied to the top portions 15A, B of the gripper arms 14A, B to cause them to pivot about pivot axes 29A, B to the open position. If tool 10 is being manually supported and manipulated by an operator's hand 63, the top portions 15A, B of the gripper arms 14A, B may be grasped and squeezed so as to open the bottom engaging portion of the tool 10 preparing it to receive the interconnect device 40. If the tool 10 is supported in an assembly machine (not shown), the machine would apply the appropriate forces to cause the gripper arms 14A, B to pivot to the open position. Similarly, if tool 50 is being manually supported and manipulated, the top portions 55A, B of the first and second members are grasped and squeezed to pivotally bias the top portions 55A and 55B toward each other. As the appropriate biasing forces are applied to the tool 10, 50, and while maintaining alignment with the interconnect device 40, it is moved toward the interconnect device 40 such that it is received between the lower ends of the gripper arms 14A, B of tool 10 and the bottom portions 57A, B of the first and second members 52A, B of the tool 50. Thereafter, the biasing forces are discontinued, thereby permitting the lower ends of the gripper arms to be biased by springs into retaining engagement with the interconnect device 40.

In an effort to avoid damage to the contacts 46, it may be desirable for the alignment features of the tool 10, 50 not to rest or otherwise touch any of the contacts 46 of the interconnect device 40. The interior edges of the tool 10, 50 are then appropriately aligned with the datum edges 44A, B, C, D, E of the interconnect device 40. The bottom surface of the tool 10, 50 may be flush against the top of the datum features 44A, B, C, D, E. A gap, or offset, from the datum edges 44A, B, C, D, E to the inside edges of the tool 10, 50, may indicate that the tool 10, 50 is not seated properly over the interconnect device 40. Thus, it may be desirable to repeat the previous step until no gap or offset exists.

After the tool 10, 50 is seated over the interconnect device 40 and has retainingly engaged it, the interconnect device 40 may be removed from the shipping tray 41, or other surface. At step 66, the tool 10, 50 and the interconnect device 40 may be transported to an assembly area.

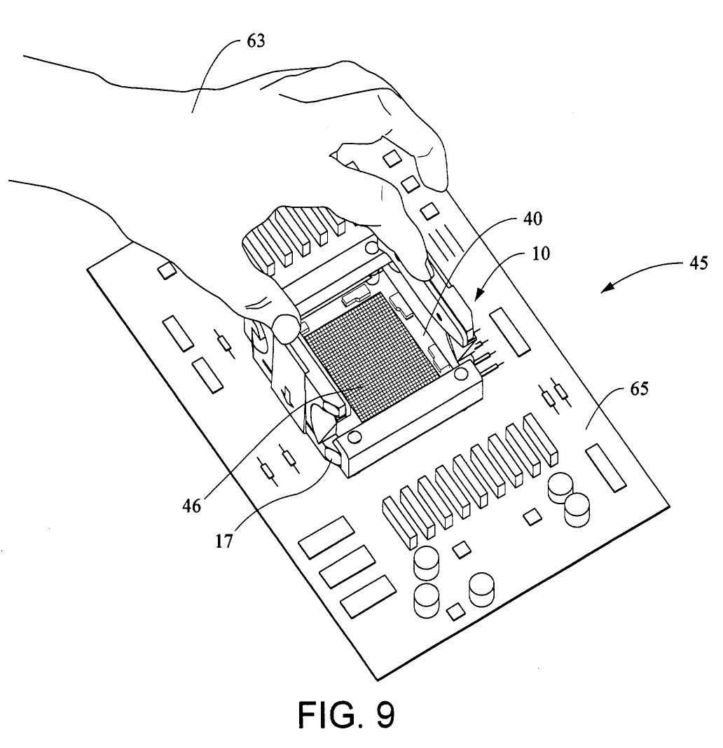

At step 68, the tool 10, 50 and the interconnect device 40 may be oriented relative to a substrate such as a printed circuit board substrate 45, as shown in FIG. 9. With the interconnect device 40 supported by the tool 10, 50, the beveled corner 48 of the interconnect device 40 then may be aligned in accordance with the bevel designation 61 on the printed circuit board substrate 45. For example, the beveled corner 48 of the interconnect device 40 may be aligned with the bevel designation 61 on the silk screen layer of the printed circuit board substrate 45.

During the alignment process, the tool 10, 50 and the interconnect device 40 combination is placed to within a few millimeters of the top side 65 of the printed circuit board substrate 45. The alignment sliders 19A, B, C, D of the tool 10, 50 may be aligned with the standoffs 47A,B, C, D to align the interconnect device 40 with the printed circuit board substrate 45 to, for example, within a few millimeters. With the tool 10 aligned on the printed circuit board substrate 45, a slight downward force in the direction toward the printed circuit board substrate 45 is applied to the top of the tool 10, 50 to place the interconnect device 40 against the printed circuit board substrate 45.

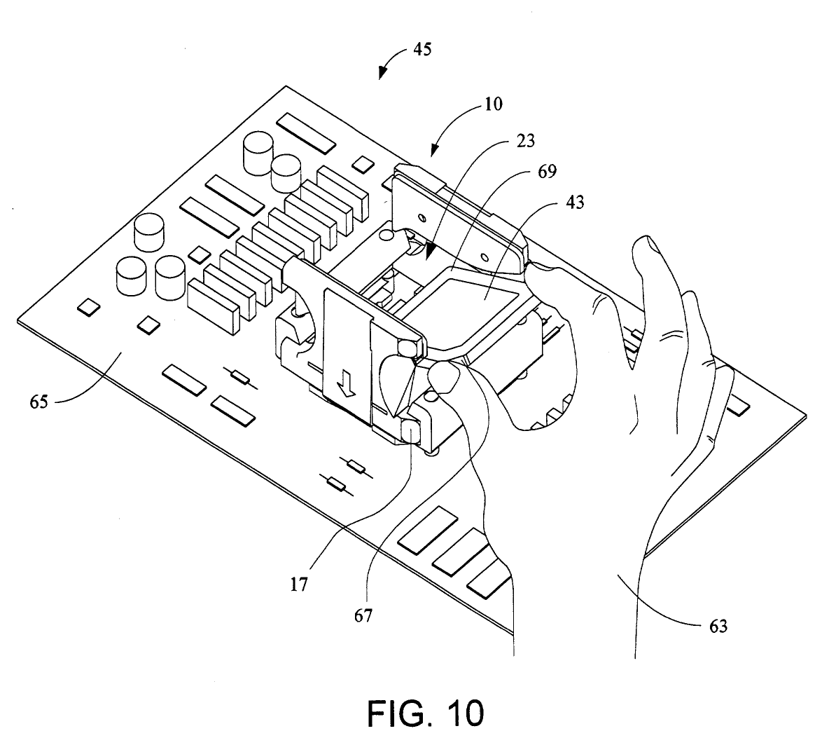

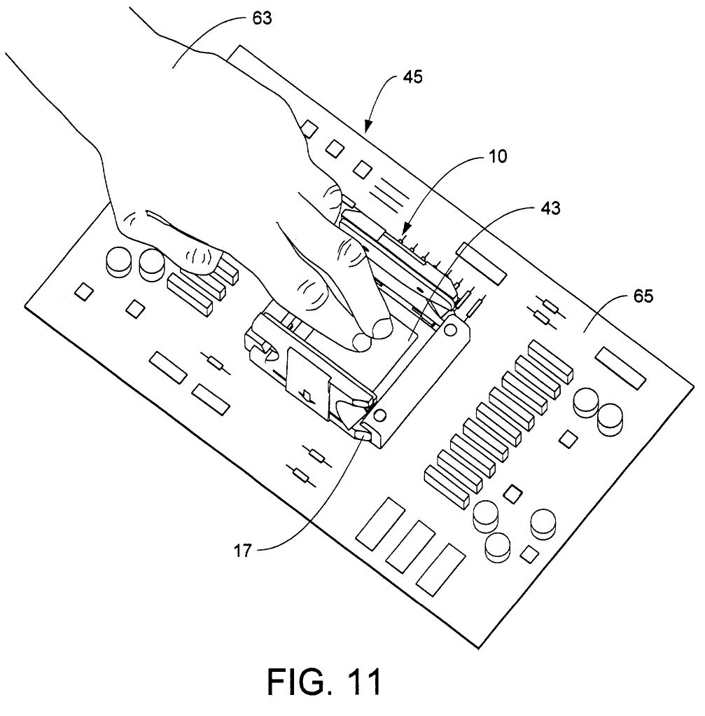

At step 70, the semiconductor component 43 may be electrically mated with the interconnect device 40. With reference now to FIG. 10, once the interconnect device 40 is placed against the printed circuit board substrate 45, the semiconductor component 43 may be inserted into the opening 23 defined by the tool 10 and placed over the interconnect device 40. The semiconductor component 43 is grasped with attention to the position of the beveled corner 67 located thereon so that it may be aligned with the beveled corner 17 of the tool 10 and the beveled corner 48 of the interconnect device 40. The semiconductor component 43 may then be lowered into the opening 23 within the tool 10, 50, and then it is released. The semiconductor component 43 drops into the tool 10, 50 and stops just short of contacting the interconnect device 40. The corner 69 opposite of the beveled corner 67 may be dropped in first to allow the semiconductor component 43 to rest against the datum surfaces 44A, B, C, D, E of the interconnect device 40. The sides adjacent to the beveled corner 17, 53 of the tool 10, 50, respectively, displace the spring arms 42A, B on the interconnect device 40 during the insertion process. As shown in FIG. 11, a downward force in the direction of the printed circuit substrate 45 may be applied to the top portion of the semiconductor component 43 to press the semiconductor component 43 into its final position wherein the interconnect device 40 and the semiconductor component 43 become electrically mated in a known manner.

Referring back to FIG. 7, at step 72 the interconnect device 40 and the semiconductor component 43 may be released from the tool 10, 50 by again applying biasing forces to the top portions 15A, B of the gripper arms 14A, B of the tool 10 and the top portions 55A, B of the first and second members 52A, B of the tool 50 to move them to open positions and maintaining the downward force on the interconnect device 40. The tool 10, 50 can then be moved away from the printed circuit board substrate 45. The tool 10, 50 is lifted away from the interconnect device 40/semiconductor component 43 combination, and the installation is complete.

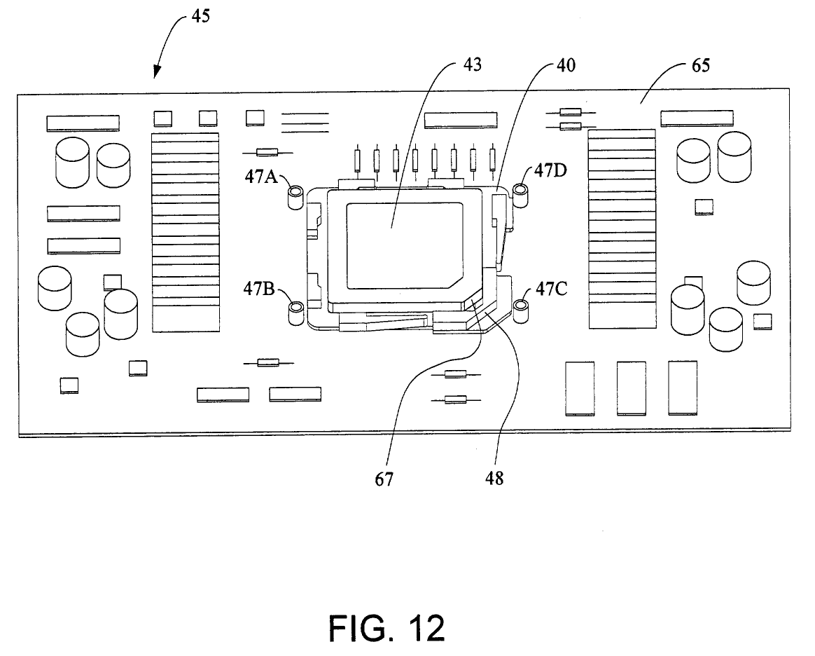

FIG. 12 illustrates one embodiment of a completed circuit board assembly. The semiconductor component 43 is electrically mated to the interconnect device 40, which is electrically mated with the printed circuit board substrate 45. Once the tool 10, 50 is removed from the interconnect device 40 the installation is completed and the procedure may be repeated for the next installation of interconnect device 40/semiconductor component 43 combination.

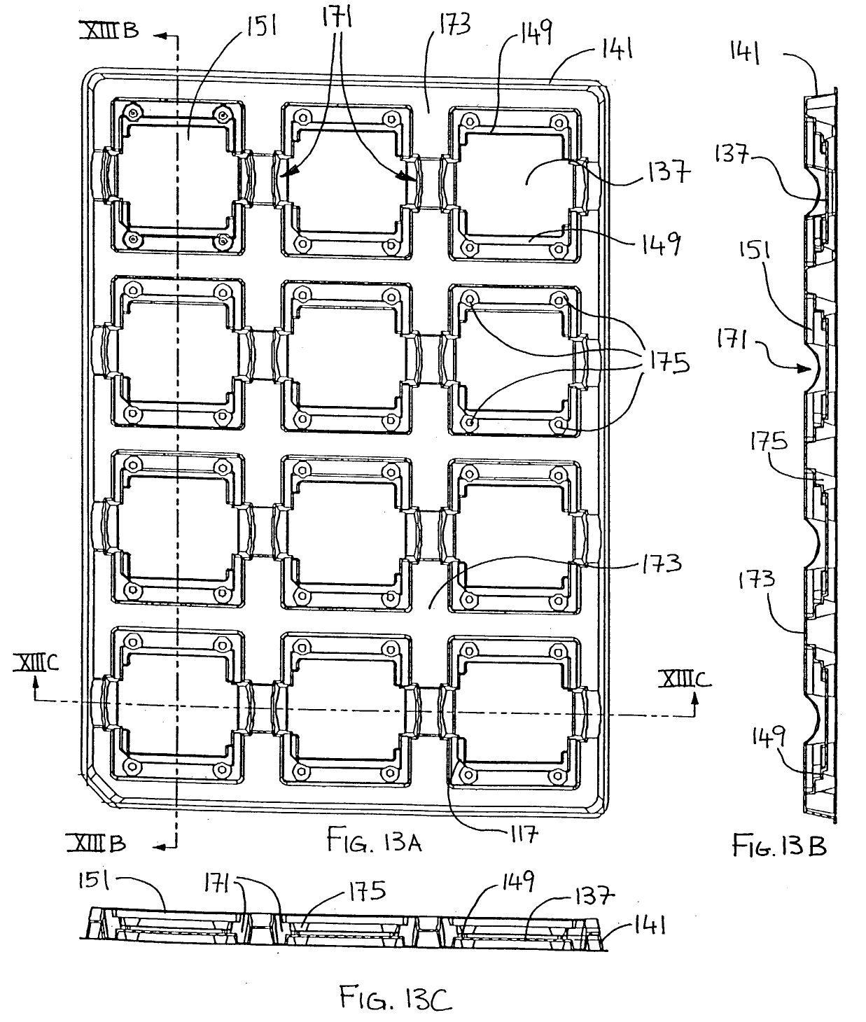

FIGS. 13A, B, and C illustrate a tray 141 according to another embodiment of the present invention. FIGS. 13B is a cross-sectional view of the tray 141 taken along line XIIIB-XIIIB in FIG. 13A. FIG. 13C is a cross-sectional view of the tray 141 taken along line XIIIC-XIIIC in FIG. 13A. The tray 141 may be used to house and transport the interconnect devices 40 as well as to present the interconnect devices 40 to the insertion tool 10. The tray 141 may serve as a work platform or work surface that presents the interconnect devices 40 to the insertion tool 10 in a pre-aligned and pre-oriented format. In addition, the tray 141 may include specific geometric features that enable the insertion tool 10 to dock, clasp, retain, and remove an interconnect device 40 and mate it to a semiconductor component 43 for subsequent placement of the mated set onto the printed circuit board substrate 45 as an integral unit. The tray 141 may be thermoformed out of a suitable plastic engineering material and may include at least one recessed cell 151 formed therein to accommodate, align, and orient the interconnect devices 40 for shipping and storing, or for presenting the interconnect devices 40 to the insertion tool 10 or the semiconductor components 43 prior to their final assembly onto the printed circuit board substrate 45.

In one embodiment of the present invention the tray 141 may include a plurality of cells 151 arranged in a matrix configuration. Each cell 151 may include a beveled corner 117 for aligning the interconnect device 40 within the cell 151. The cell 151 also may include a planar lower surface 137 and a support surface 173. The cell 151 also includes ledge segments 149 for holding the interconnect device 40 within the cell 151. Each cell 151 also may include access recesses 171 that define a space allowing the gripper arms 14A, B to move to an open position for receiving and engaging the interconnect device 40 therebetween in order to retrieve the interconnect device 40 from the tray 141. In one embodiment of the present invention, the access recesses 171 may take the form of cavities defined within the support surface 173 of the tray 141 and also may take the form of openings defined between adjacent cells 151. The cell 151 also may include one or more alignment recesses 175 that serve to position, align, and guide the insertion tool 10 over and onto the tray cell 151. In one embodiment of the invention the four alignment sliders 19A, B, C, D of the tool 10 may be aligned with the alignment recesses 175 to align and dock the tool 10 over the interconnect device 40.

Those of ordinary skill in the art will recognize that many modifications and variations of the present invention may be implemented. For example, although the various components of the tool 10 are described as being removably attached to the body 12, these components and the body 12 may be integrally formed as a single component such that they are permanently attached to each other yet are oriented to function in the various manners described above. The foregoing description and the following claims are intended to cover all such modifications and variations. Furthermore, the materials and processes disclosed are illustrative, but are not exhaustive. Other materials and processes may also be used to make devices embodying the present invention.

1. An apparatus, comprising:
a body having at least one alignment guide thereon, the body defining an opening for receiving a semiconductor component therein; and
a first gripper arm pivotally attached to the body.

2. The apparatus of claim 1, further comprising a second gripper arm pivotally attached to the body.

3. The apparatus of claim 1, further comprising at least one alignment slider slidably supported within the body and protruding from a bottom portion thereof.

4. The apparatus of claim 3, further comprising a spring corresponding to each the alignment slider for providing a biasing force thereto.

5. The apparatus of claim 1, wherein the at least one alignment guide comprises a chamfered surface on the body.

6. The apparatus of claim 1, wherein the at least one alignment guide is reversibly attachable to the body.

7. The apparatus of claim 1, wherein the body is fabricated from aluminum.

8. The apparatus of claim 1, wherein the body is fabricated from an epoxy-based non-abrasive material.

9. A semiconductor insertion apparatus, comprising:
a body defining an opening for receiving a semiconductor component therein;
a first gripper pivotally coupled to the body; and
a second gripper pivotally coupled to the body in opposition with the first gripper.

10. The apparatus of claim 9 wherein the first and second grippers are selectively pivotable between open and closed positions and wherein the apparatus further comprises:
a first biaser supported between a portion of the body and the first gripper to bias the first gripper to the closed position; and
a second biaser supported between another portion of the body and the second gripper to the closed position.

11. The apparatus of claim 9 further comprising at least one alignment slider slidably supported in a portion of the body and protruding therefrom.

12. The apparatus of claim 11, wherein each the alignment slider has an alignment head and wherein the apparatus further comprises an alignment biaser corresponding to each the alignment slider and supported by the body to bias the alignment head to each the alignment slider away from the body.

13. The apparatus of claim 9 wherein the body has a first end and a second end and wherein the apparatus further comprises at least one guide protruding from the first end of the body.

14. The apparatus of claim 13 further comprising at least one other guide protruding from the first end of the body.

15. The apparatus of claim 14 wherein the guide and the other guide may be selectively coupled to either of the first and second ends of the body.

16. Apparatus for releasably supporting a semiconductor interconnect device, comprising:
a body;
first means for gripping the interconnect device, the first means movably coupled to the body; and
second means for gripping the interconnect device, the second means movably coupled to the body.

17. The apparatus of claim 16 further comprising guide means on the body for aligning the body relative to a surface.

18. Apparatus for coupling a semiconductor component to a substrate, the apparatus comprising:
an interconnect device; and
a placement tool comprising:
a body having opening therein for receiving a semiconductor component; and
at least one gripper movably attached to the body for selectively gripping and supporting the interconnect device.

19. The apparatus of claim 18 wherein the interconnect device comprises:
a frame having at least one guide portion for cooperating with a portion of the placement tool for aligning and orienting the placement tool relative to the interconnect device.

20. The apparatus of claim 19 wherein the guide portion on the frame comprises a plurality of datum edges on the frame.

21. The apparatus of claim 19 wherein the guide portion of the frame comprises a portion of the frame shaped to correspond with a complementary shaped portion of the body of the placement tool.

22. The apparatus of claim 21 wherein the portion of the frame shaped to correspond with the complementary shaped portion of the body comprises a beveled edge on the frame shaped to correspond with another beveled edge on the body of the placement tool.

23. The apparatus of claim 18 wherein the interconnect device comprises:
a frame;
a plurality of contacts on the frame; and
at least one spring-biased retainer arm coupled to the frame.

24. The apparatus of claim 23 further comprising:
a spring arm depressor corresponding to at least one the spring-biased retainer arm, such that when the interconnect device is retained by the at least one gripper on the placement tool the spring arm depressor biases the corresponding spring-biased retainer to a component-receiving position.

25. Apparatus for coupling a semiconductor component to a substrate, the apparatus comprising:
an interconnect device; and
a placement tool comprising:
a body having an opening therein for receiving a semiconductor component; and
gripping means attached to the body for selectively gripping the semiconductor component.

26. The apparatus of claim 25 wherein the interconnect device comprises:
a frame;
means on the frame for orienting the body of the placement tool relative to the frame;
means supported on the frame for establishing an electrical connection with a semiconductor component received on the frame; and
means on the frame for selectively retaining the semiconductor component on the frame.

27. The apparatus of claim 26 further comprising depressor means on the body of the placement tool for coacting with the means for selectively retaining such that when the interconnect device is retained by the means for gripping, the means for selectively retaining permits the semiconductor component to be installed on the frame and removed therefrom.

28. A semiconductor component system, comprising:
a substrate;
a semiconductor component;
an interconnect device for interconnecting the semiconductor component to the substrate; and
a placement tool comprising:
a body; and
a pair of opposed grippers on the body for selectively retaining and releasing the interconnect device.

29. The system of claim 27 wherein the semiconductor component has a plurality of contacts and wherein the interconnect device comprises:
a frame defining an interior area sized to receive the semiconductor component therein;
a plurality of other contacts in the interior area for electrically mating with the contacts on the semiconductor components; and
at least one retainer arm on the frame and being movable from a retaining position wherein the semiconductor component is retained on the interconnect device and another position wherein the semiconductor component may be installed on and removed from the interconnect device.

30. The system of claim 28 further comprising at least one depressor on the placement tool for moving the at least one retainer arm to the other position when the interconnect device is retained by the opposed grippers.

31. The system of claim 28 further comprising a guide portion on the frame and another guide portion on the body of the placement tool such that the guide portion on the frame cooperates the other guide on the body to orient the body in a desired orientation relative to the frame.

32. The system of claim 27 wherein the substrate comprises a printed circuit board.

33. The system of claim 31 further comprising a substrate guide on the printed circuit board; and a guide on the interconnect device such that when the guide on the interconnect device is aligned with the substrate guide on the printed circuit board, the interconnect device is oriented in a desired orientation relative to the printed circuit board.

34. The system of claim 32 wherein the substrate guide comprises a bevel designation on the printed circuit board and wherein the guide on the interconnect device comprises a beveled edge on the interconnect device.

35. The system of claim 27 further comprising:
a guide portion on the semiconductor component; and
a guide portion on the body of the placement tool; the guide on the semiconductor tool cooperating with the guide portion on the body to orient the semiconductor component in a desired orientation when the semiconductor component is inserted into the opening.

36. The system of claim 27 further comprising:
at least one alignment member on the body of the placement tool; and
an area on the substrate corresponding to each the alignment member such that when the alignment members are aligned with the corresponding areas on the substrate, the placement tool is oriented at a desired alignment relative to the substrate.

37. The system of claim 35 wherein the alignment members are slidably supported in the body portion and each have a head portion protruding from a lower portion of the body of the placement tool.

38. The system of claim 36 further comprising a biasing member supported within the body to apply a biasing force to each the alignment member.

39. The system of claim 36 wherein the areas on the substrate comprise a plurality of standoff members protruding therefrom.

40. An apparatus, comprising:
a first member having a top portion and a bottom portion, the first member having a first downwardly projecting edge;
a second member having a top portion and a bottom portion, the second member located opposite the first member and pivotally attached to the first member, the second member having a second downwardly projecting edge; and
a biaser disposed between the first and second members for applying biasing forces to the first and second members to bias the bottom portions of the first and second members toward one another for releasably retaining an interconnect device between the first and second downwardly projecting edges.

41. A tray for receiving interconnect devices, comprising:
a cell, comprising:
a planar lower surface;
a support surface formed on the lower surface; and
an access recess formed within the support surface.

42. The tray of claim 41, further comprising a plurality of cells.

43. The tray of claim 42, wherein the plurality of cells are arranged in a matrix configuration.

44. The tray of claim 41, wherein the support further comprises at least one ledge segment.

45. The tray of claim 44, further comprising a plurality of ledge segments.

46. The tray of claim 41, wherein the access recess is a cavity formed within the support.

47. The tray of claim 41, wherein the access recess is an opening defined between adjacent cells.

48. The tray of claim 41, further comprising a bevel formed on one of the ledge segments for orienting an interconnect device within the cell.

49. The tray of claim 41, further comprising at least one alignment recess formed on the cell.

50. A method of assembling a semiconductor component using an insertion tool, the method comprising:
aligning an insertion tool with an interconnect device;
retainably engaging the interconnect device with the insertion tool;
transporting the interconnect device to an assembly area;
placing the interconnect device on a substrate;
inserting a semiconductor component into the interconnect device; and
releasing the interconnect device and the semiconductor component from the tool.
